(19) United States
(12) Patent Application Publication
(10) Pub. No.: US 2011/0126464 A1
(43) Pub. Date: Jun. 2, 2011

(54) Interior plantation window shutter

(75) Inventors: Lawrence Matthew Stone, Logan, UT (US); Richard William Gaskey, JR., Temecula, CA (US)

(73) Assignee: Global Precision Products LLC, Temecula, CA (US)

(21) Appl. No.: 12/801,088

(22) Filed: May 20, 2010

Related U.S. Application Data
(60) Provisional application No. 61/216,731, filed on May 21, 2009.

(51) Int. Cl. E06B 7/096; E06B 7/08; E06B 7/086

(52) U.S. Cl. 49/82.1; 49/92.1; 49/90.1; 49/506

(57) ABSTRACT

A plantation window shutter, comprises a frame and a plurality of shutter blades pivotably supported by the frame. The frame has a left stile, a right stile, a bottom rail connected to the left and right stiles and a top rail connected to the left and right stiles. The left stile comprises first and second members joined together, and the right stile third and fourth members joined together. The bottom rail includes first and second end portions sandwiched between the first and second members, and the third and fourth members, respectively. The top rail includes first and second end portions sandwiched between the first and second members, and the third and fourth members, respectively. The left and right stiles include top end portions operably attached to each other. The first and second members have opposing sides including a plurality of mirrored left grooves. The third and fourth members have opposing sides including a plurality of mirrored right grooves, the mirrored left grooves being axially aligned with respective the mirrored right grooves. Each of the shutter blades has a longitudinal pivotal axis and a left pivot and a right pivot aligned along the axis, the left pivot and the right pivot being received in respective one of the mirrored left grooves and the mirrored right grooves.

### RELATED APPLICATION

This is a nonprovisional application claiming the priority benefit of provisional application Ser. No. 61/216,731, filed May 21, 2009, herein incorporated by reference.

### FIELD OF THE INVENTION

The present invention relates generally to a window shutter and a method of making the same and particularly to an indoor plantation window shutter.

### BACKGROUND OF THE INVENTION

Plantation window shutters are currently built by hand by cutting several extruded lengths of plastic material or pre-machined profiles of wood. Manufacturers of window shutters use a variety of wood working hand tools, complex formulas and highly trained expensive craftsmen. The present invention provides additional ways for manufacturing plantation window shutters that reduce costs, improve quality, and reduce dramatically the time it takes to build them.

### SUMMARY OF THE INVENTION

The present invention provides a plantation window shutter, comprising a frame and a plurality of shutter blades pivotably supported by the frame. The frame has a left stile, a right stile, a bottom rail connected to the left and right stiles and a top rail connected to the left and right stiles. The left stile comprises first and second members joined together, and the right stile third and fourth members joined together. The bottom rail includes first and second end portions sandwiched between the first and second members, and the third and fourth members, respectively. The top rail includes first and second end portions sandwiched between the first and second members, and the third and fourth members, respectively. The left and right stiles include top end portions operably attached to each other. The first and second members have opposing sides including a plurality of mirrored left grooves. The third and fourth members have opposing sides including a plurality of mirrored right grooves, the mirrored left grooves being axially aligned with respective the mirrored right grooves. Each of the shutter blades has a longitudinal pivotal axis and a left pivot and a right pivot aligned along the axis, the left pivot and the right pivot being received in respective one of the mirrored left grooves and the mirrored right grooves.

The present invention also provides a method for making a plantation window shutter, comprising the steps of sending to a remote computer measurements of a window opening in which a window shutter will be installed; providing a sheet material from which components of the window shutter will be cut; providing a CNC router machine for cutting the sheet material; receiving by the CNC router machine from the remote computer a machine file configured for operating the CNC router machine to cut the sheet material to produce the components of the window shutter; and assembling the components.

### BRIEF DESCRIPTION OF THE DRAWINGS

FIG. 1 is a front perspective view of window shutter embodying the present invention.

FIG. 2 is a partial assembly view of FIG. 1.

FIG. 3 is an assembly view of the shutter shown in FIG. 1.

FIG. 4 is a cross-sectional view taken along line 4-4 in FIG. 1.

FIG. 5 is a fragmentary assembly view of a shutter blade.

FIG. 6 is an end view of a pivot taken along line 6-6 in FIG. 5.

FIG. 7 is an end view of a pivot showing a spline keyed portion.

FIGS. 8 and 9 are end views of extruded shutter blades that may be used in the window shutter of the present invention.

FIG. 10 is a cross-sectional view of a section of the gear rack used in the present invention, showing a keyed axial openings for the gears used in the embodiment of FIG. 1.

FIG. 11 is a cross-sectional view taken along line 11-11 in FIG. 1.

FIG. 12 is a cross-sectional view taken along line 12-12 in FIG. 1.

FIG. 13 is a cross-sectional view taken along 13-13 in FIG. 1, showing the shutter blades in the closed position.

FIG. 14 is similar to FIG. 13, showing the shutter blades in the open position.

FIG. 15 is a cross-sectional view taken along line 15-15 in FIG. 1.

FIG. 16 is perspective view of another embodiment of a window shutter embodying the present invention.

FIG. 17 is a partial assembly view of FIG. 16.

FIG. 18 is a cross-sectional view taken along line 18-18 in FIG. 16.

FIG. 19 is a cross-sectional view taken along line 19-19 in FIG. 16.

FIG. 20 is a partial cross-sectional of another embodiment of the window shutter shown in FIG. 16, showing elliptical-shaped extruded shutter blades.

FIG. 21 is a schematic perspective view of a CNC router machine used in the present invention.

FIG. 22 is a functional block diagram of a system used in making the shutter of FIG. 1.

FIG. 23 is a flowchart of a system used in making the shutter of FIG. 1.

FIGS. 24-25 show exemplary input window measurements.

FIGS. 26(a)-26(f) illustrate examples of the various cross-sectional profiles of a frame that may be used with the window shutter of FIG. 1.

FIG. 27 illustrates an example calculation in reducing the size of the shutter of FIG. 1 to account for the dimensions of a separate frame around the shutter of FIG. 1.

FIG. 28 shows a sheet material with an example of the various cuts made by the CNC router machine on one side of a board to make the components of the window shutter shown in FIG. 1.

FIG. 29 shows the other side of the sheet material of FIG. 28, showing the various cuts made the CNC router machine.

### DETAILED DESCRIPTION OF THE INVENTION

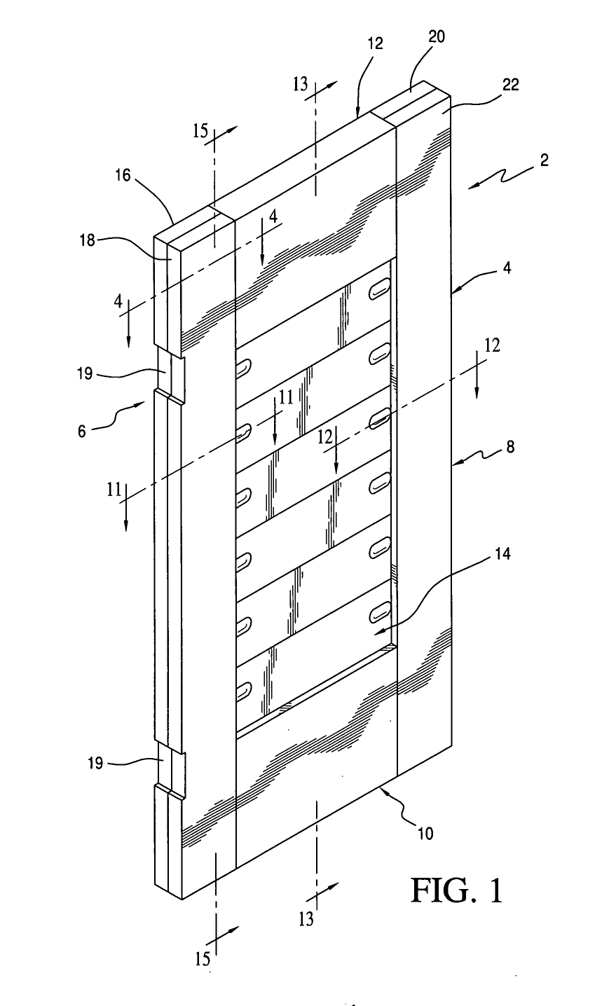

Referring to FIG. 1, an indoor window shutter 2 embodying the present invention is disclosed. The shutter 2 has a frame 4 having a left stile 6, a right stile 8, a bottom rail 10, a top rail 12 and a plurality of shutter blades 14 pivotably supported by the frame 4 in a horizontal configuration. The left stile 6 is made of separate longitudinal members 16 and 18 attached together, preferably with glue, screws or other conventional ways. The members 16 and 18 may include matching hinge cutouts or recesses 19. Similarly, the right stile 8 is made of separate longitudinal members 20 and 22 joined together in the same manner as the members 16 and 18. Preferably, the member 16 is a mirror image of the member 18. Similarly, the member 20 is preferably a mirror image of the member 22. Preferably, all the members 18-22 are identical to each other for simplicity in manufacture. The rails 10 and 12 are also identical to each other for ease of manufacture.

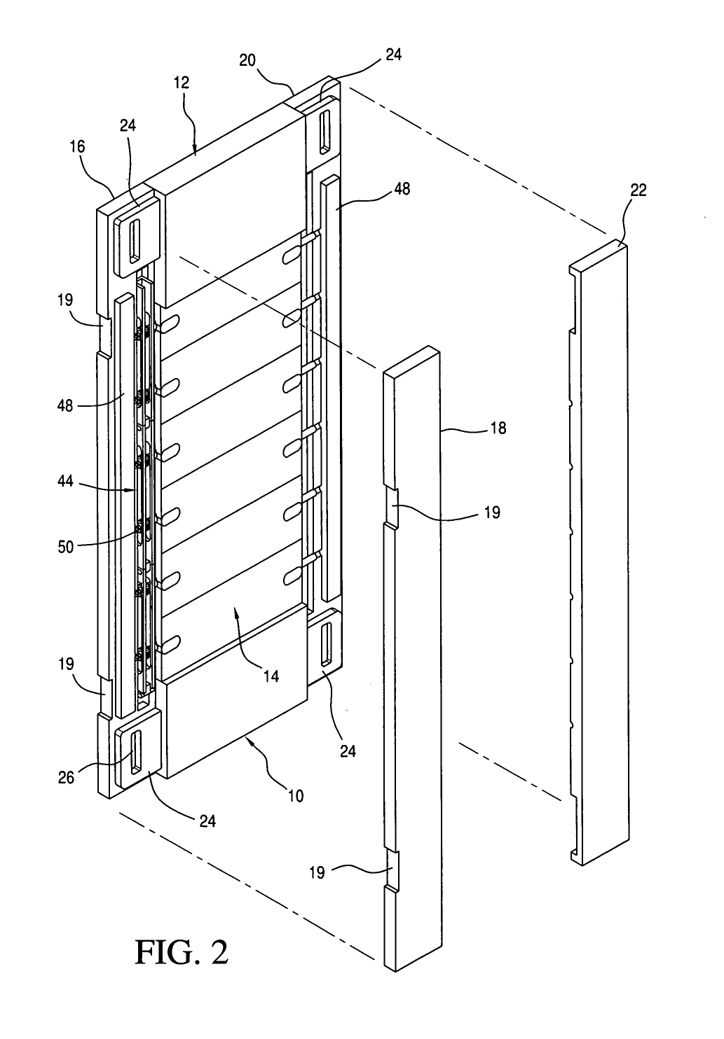

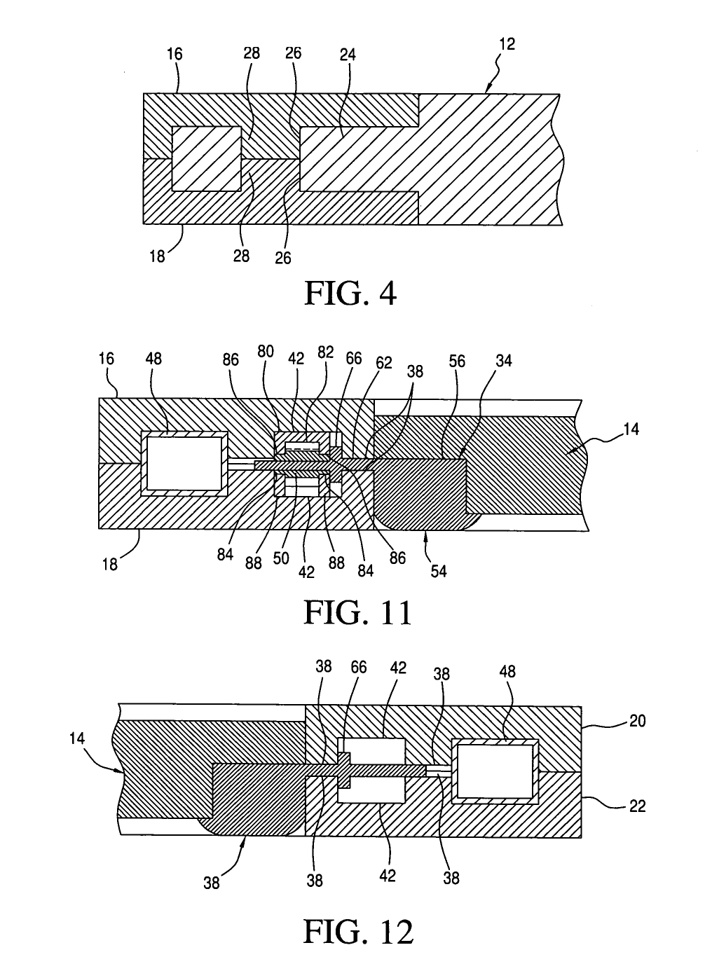

Referring to FIGS. 2, 3 and 4, the bottom rail 10 and the top rail 12 each have end portions 24 that are sandwiched between the respective end portions 30 of the members 16 and 18, and members 20 and 22. Each end portion 24 has an opening 26 that receives a projection 28 on the corresponding end portion 30 of the members 16, 18, 20 and 22. Each end portion 24 is further received into a recess 32 in the corresponding end portion 30 of the members 16-22. Although the projections 28 are shown as rectangular in plan view, and the openings 26 are of similar shape and size, the projections 28 can be of a different shape, such as a pair of spaced apart cylindrical projections and the openings 26 a pair of correspondingly sized and spaced holes. The projections and the corresponding openings are preferably configured to hold the rails at right angle to the stiles when the projections are received in the corresponding openings, thereby saving time during the assembly.

Each shutter blade 14 has left pivot 34 and right pivot 36 rotatably received within left groove 38 and right groove 40 in the corresponding members 16-22. Left grooves 38 in the members 16 and 18 are mirror images of each other (mirrored grooves). A groove 38 in the member 16 and the corresponding opposing groove 38 in the member 18 provide sufficient clearance for the left pivot 34 to rotate therein. Similarly, right grooves 40 in the members 20 and 22 are mirror images of each other (mirrored grooves) and that a groove 40 in the member 20 and the corresponding opposing groove 40 in the member 22 provide sufficient space for the right pivot 36 to rotate therein. It should be understood that the left grooves 38 and the right grooves 40 may be completely provided in the two laterally spaced members, such as the members 16 and 20, or the members 18 and 22, thereby obviating the need for providing opposing mirrored grooves in the members 16-22.

The pivots 34 and 36 are aligned along a longitudinal axis of rotation of the corresponding shutter blade 14.

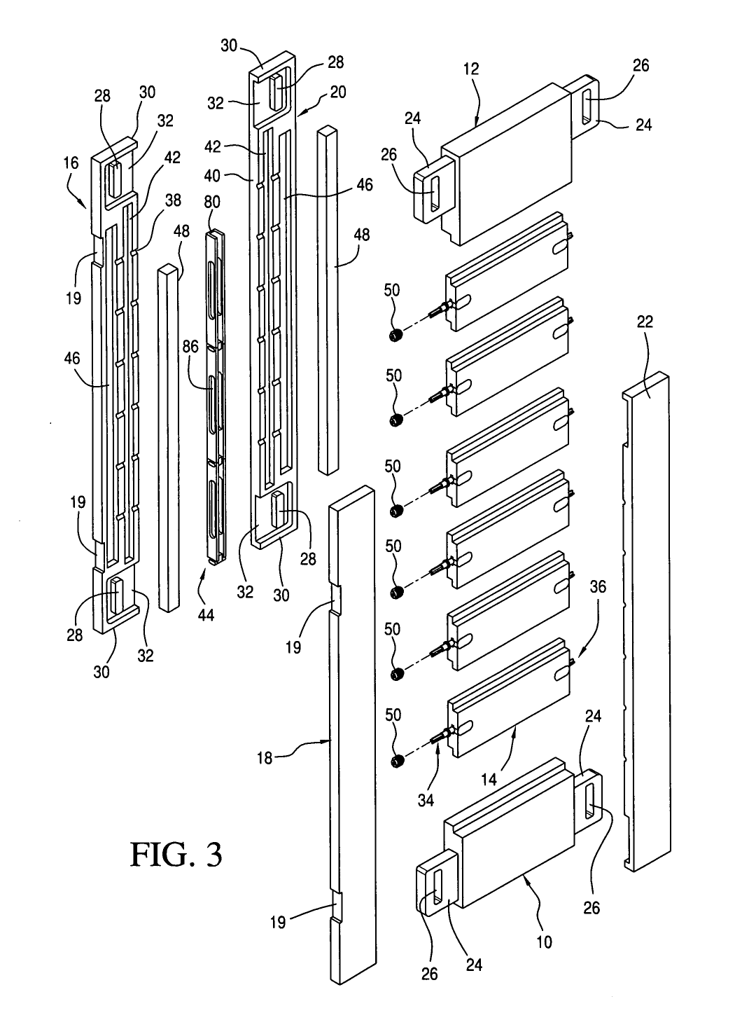

Referring to FIG. 3, longitudinal slots 42 are provided in the members 16-22. The slots 42 intersect and are preferably disposed perpendicular to the grooves 38 and 40. The slot 42 in the member 16 is preferably a mirror image of the slot 42 in the member 18 (mirrored slots). Similarly, the slot 42 in the member 20 is preferably a mirror image of the slot 42 in the member 22 (mirrored slots). A gear rack 44 is slidably disposed within the opposing slots 42 in the members 16 and 18 (see FIG. 12). The rack 44 may also be disposed in the opposing slots 42 in the members 20 and 22. The slots 42 are longer than the length of the gear rack 44 to allow the gear rack 44 to translate up and down as the shutter blades 14 are turned, as will be explained further below.

Another slot 46 is disposed in each of the members 16-22. The slots 46 are preferably substantially parallel to the slots 42. The slot 46 in the member 16 is a mirror image of the slot 46 in the member 18 (mirrored slots). Similarly, the slot 46 in the member 20 is a mirror image of the slot 46 in the member 22 (mirrored slots). A stiffener 48 is received within the corresponding pair of mirrore 46 (see FIG. 11). The slots 46 are routed with a very close tolerance to the same size as the stiffener 48 for a pressed fit. The stiffener 48 is preferably in cross-section a square tube, but other cross-sectional shapes may be used, such as U-shaped, I-shaped or V-shaped and made of metal, wood, plastic, fiberglass or other suitable material so as to provide stiffness and strength to the frame 4 and restrict the stiles from twisting and flexing after they are glued together.

Each of the pivots 34 is associated with a gear 50, which is in meshing engagement with the gear rack 44. The gears 50 are fixedly attached to the respective pivot 34 so that when the shutter blade 14 is rotated by hand, the associated gear 50 turns with the associated pivot 34, which in turn causes the gear rack 44 to translate within the slots 42 that in turn causes the other gears 50 to turn, thereby actuating the other shutter blades 14 to turn in the same direction as the shutter blade being manually turned by hand.

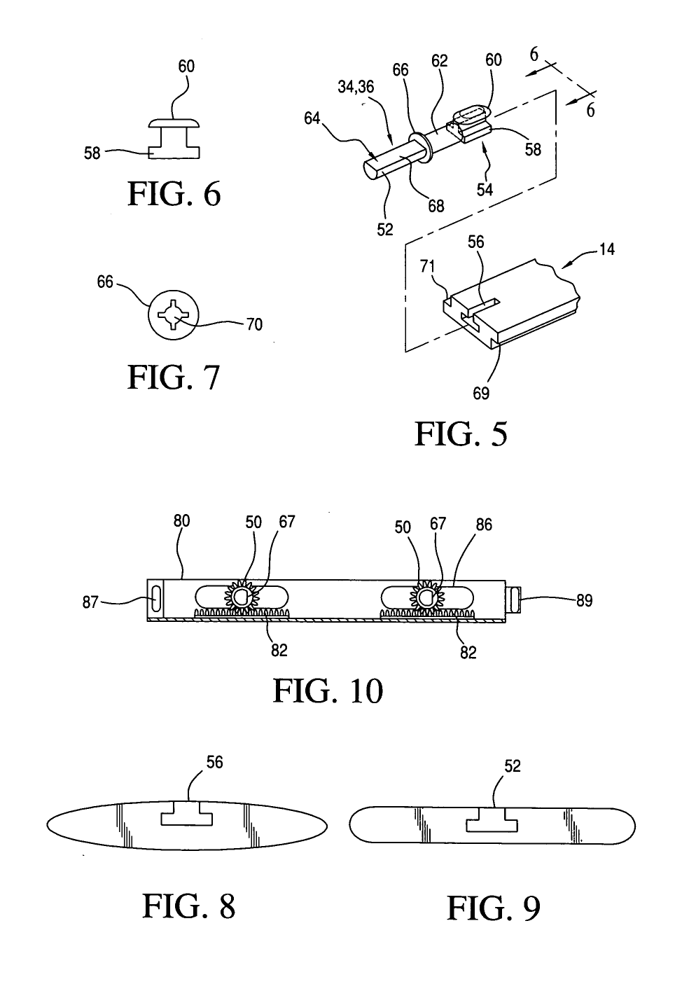

Referring to FIG. 5, each pivot 34 or 36 has a shaft portion 52 and an attachment portion 54. The attachment portion 54 is receivable with a respective T-shaped slot 56 at each end of each blade 14. The attachment portion 54 has a T-shaped portion 58 when viewed in cross-section that is receivable within the T-shaped slot 56, preferably with a friction fit, as shown in FIG. 6. The attachment portion 54 also includes a cover portion 60 that overlies and covers the slot 56 when the attachment portion 54 is inserted into the slot 56.

The shaft portion 52 of the pivot 34 preferably includes a cylindrical portion 62 and a keyed portion 64, separated by a flange portion 66. The cylindrical portion 62 is receivable within the respective grooves 38 and 40. The keyed portion 64 may include a flat surface 68 that engages a corresponding flat portion 67 (see FIG. 10) in the axial opening in the gear 50 to provide a positive engagement between the pivot 34 and the gear 50. It should be understood that other standard means of positive attachment between the pivots 34 and the gears 50 may be used, such as a plurality of splines 70, as shown in FIG. 7, that engage with correspondingly shaped opening in the gear 50. The pivots 34 and 36 are preferably molded from plastic or other suitable material.

The shutter blade 14 has its longitudinal edges 69 and 71 recessed, so that in the closed position, the shutter blades longitudinal edges overlap one another to provide a substantially flush appearance. The shutter blades 14 may have other profiles, such as elliptical or oblong, as shown in FIGS. 8 and 9.

Referring to FIGS. 10 and 11, the gear rack 44 has a U-shaped frame 80 and a linear gear 82 attached to the bottom portion of the frame 80. The gear 50 has a cylindrical extension 84 on each axial end that rides along a longitudinal slot 86 in each side wall 88 of the frame 80. The gear 50 meshes with the linear gear 52. The pivot 34 is shown with a flat portion 68 that keys with a correspondingly shaped opening in the gear 50. The cylindrical portion 62 rotates within the mirrored grooves 38.

The gear rack 44 is made of several sections joined end to end, one section of which is shown in FIG. 10. The section has a pair of openings 87 in the side walls 88 that receive a pair of tabs 89 that snap into the openings 87 in the next section, thereby lengthening the gear rack as desired to fit any shutter height.

Referring to FIG. 12, the mirrored slots 42 in the members 20 and 22 are shown empty, since the gear rack 44 is disposed in the other mirrored slots 42 located in the members 16 and 18. It should be understood that the gear rack 44 may be disposed in the mirrored slots 42 in the members 20 and 22, instead of in the mirrored slots 42 in the members 16 and 18, in which case the gears 50 will be attached to the right pivots 36.

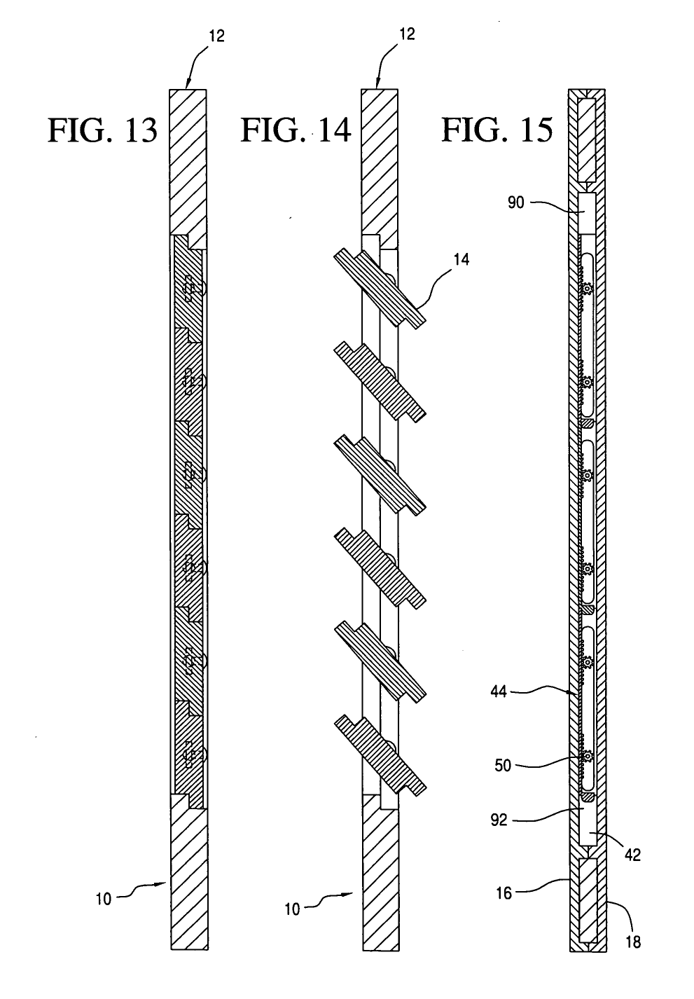

Referring to FIGS. 13-15, the shutter blades 14 are operated from a closed position to an open position and back to the closed position by turning one of the shutter blades 14. As the actuated shutter blade rotates, its associated gear 50 rotates, thereby causing the gear rack 44 to translate downwardly or upwardly within the slot 42. Empty spaces 90 and 92 at the top and bottom, respectively, of the gear rack 44, allow the gear rack 44 to move within the slot 42. From a closed position, as shown in FIG. 13, when one of the shutter blades 14 is rotated counter-clockwise, the associated gear 50 will move counter-clockwise, which in turn will cause the gear rack 44 to move downwardly. The movement of the gear rack 44 will drive the other gears 50 to rotate counter-clockwise, thereby also moving the other shutter blades 14 in the counter-clockwise direction to the open position. Similarly, from the open position shown in FIG. 14, when one of the shutter blades 14 is rotated clockwise, the associated gear 50 will rotate clockwise, driving the gear rack 44 to move upwardly, thereby driving all the other gears 50 to rotate clockwise to the closed position.

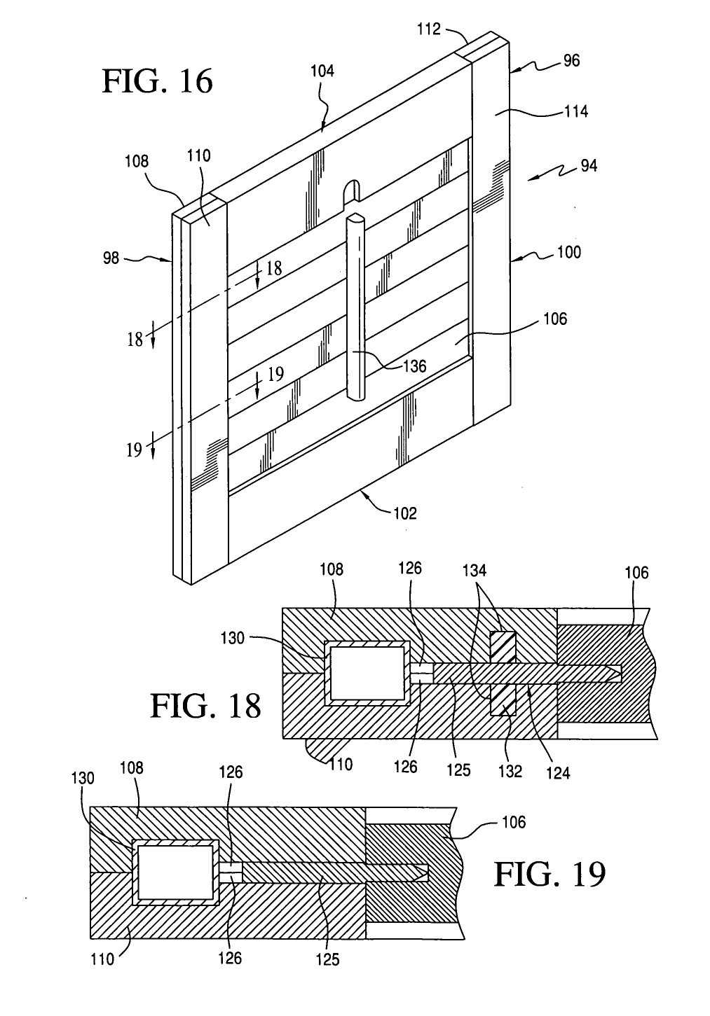

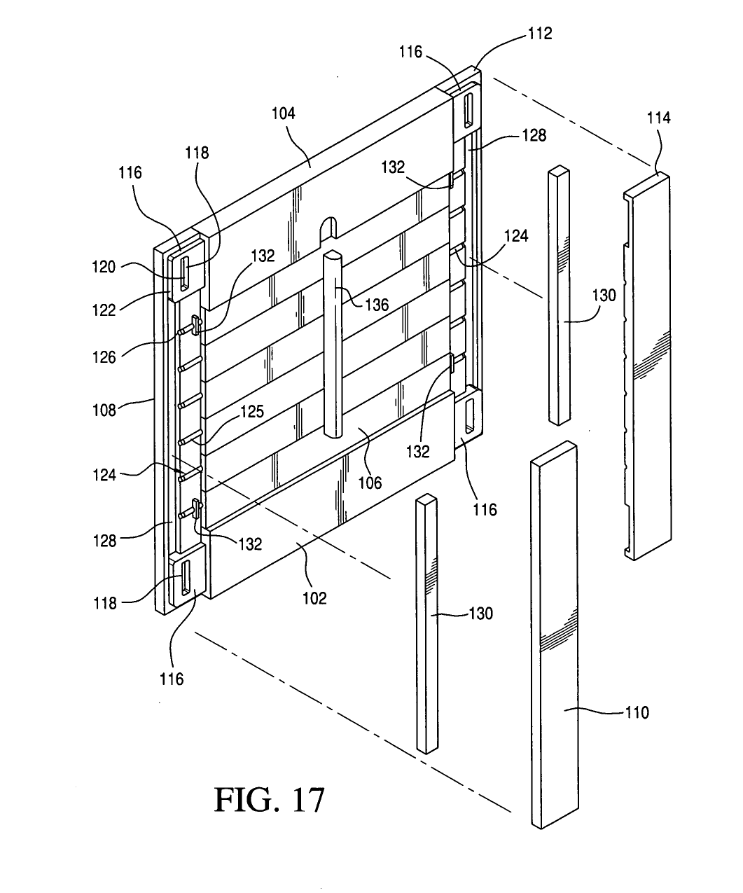

Referring to FIGS. 16 and 17, another embodiment of a window shutter 94 embodying the present invention is disclosed. The shutter 94 has a frame 96 having a left stile 98, a right stile 98, a bottom rail 102, a top rail 104 and a plurality of shutter blades 106 pivotably supported by the frame 96 in a horizontal configuration. The left stile 98 is made up of separate longitudinal members 108 and 110 attached together, preferably with glue, screws or other conventional ways. The members 108 and 110 may include hinge cutouts or recesses. Similarly, the right stile 96 is made up of separate longitudinal members 112 and 114 joined together in the same manner as the members 108 and 110. Preferably, the member 108 is a mirror image of the member 110. Similarly, the member 112 is preferably a mirror image of the member 114. All the members 108-114 are preferably identical to one another for each of manufacture.

Referring to FIGS. 17, 18 and 19, the bottom rail 102 and the top rail 104 each have end portions 116 that are sandwiched between the members 108 and 110, and members 112 and 114. Each end portion 116 has an opening 118 that receives a projection 120 on the corresponding end portion of the members 108, 110, 112 and 114. Each end portion 116 is further received into a recess 122 in the corresponding end portion of the members 108-114.

Each shutter blade 106 has left and right pivots 124, which includes shaft portions 125 rotatably received within respective grooves 126 in the corresponding members 108-114. A groove 126 in the member 108 mates with a mirror image groove 126 (mirrored grooves) in the member 110 to provide enough clearance for the shaft portions 125 to rotate therein. It should be understood that the grooves 126 may be completely provided in the two laterally spaced members, such as the members 108 and 112, or the members 110 and 114, thereby obviating the need for providing mirrored grooves in the members 108-114.

The pivots 124 are aligned along a longitudinal axis of rotation of the corresponding shutter blade 106.

Referring to FIGS. 17, 18 and 19, a longitudinal slot 128 is disposed in each of the members 108-114 longitudinally of the members. Each slot 128 is a mirror image of the slot in the opposite member. Stiffeners 130 are received with the mirrored slots 128. The stiffeners 130 are preferably tubular and square in cross-section. They may also be of other suitable cross-sectional shapes, such as U-shaped, I-shaped or V-shaped and made of metal or other suitable material to provide stiffness and strength to the frame 96.

Referring to FIGS. 17 and 18, the top and bottom shutter blades 106 may be provided with a respective friction washer 132, preferably rectangular so that it can be held stationary within correspondingly shaped slots while the shutter blades 106 are actuated. Each washer 132 is preferably made of compressible material, such as rubber or elastomeric plastic, and is attached to the shaft portion 125 of the respective pivots 124. The washer 132 has a friction fit with the shaft portion 125 that allows the respective shutter blade 106 to be pivoted within its range of motion and be held secured to its pivoted position without looseness. Each washer 132 is disposed within respective slots 134 in the respective members 108-114.

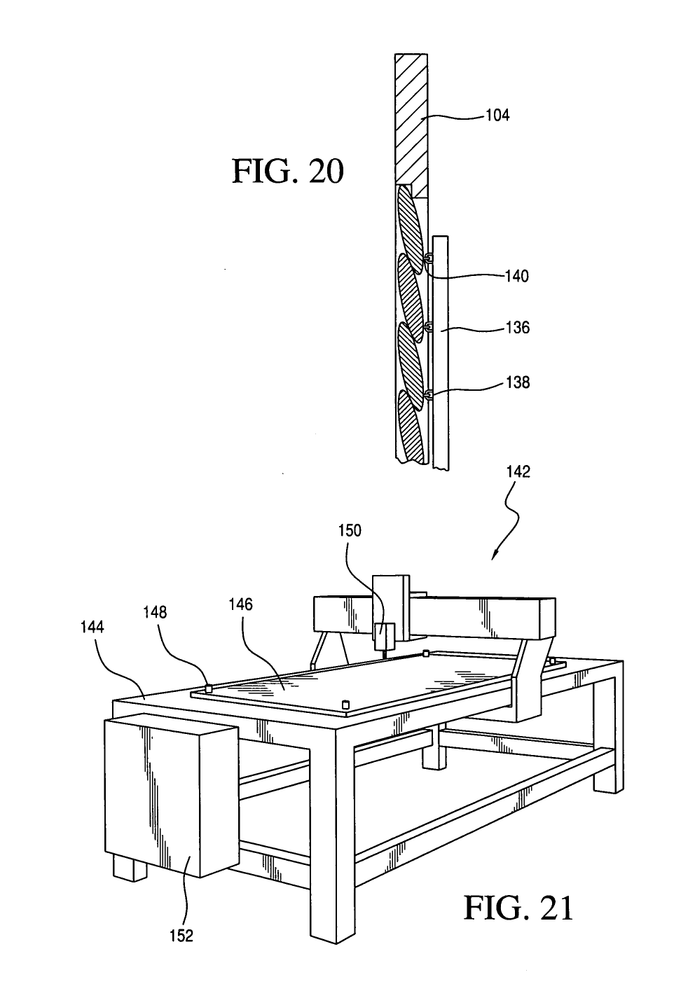

A control rod 136 is hingedly attached to each shutter blade 106 for operating the shutter blades in the open or closed position. Referring to FIG. 20, showing the shutter blades with an elliptical profile, the control rod includes staples 138 attached to corresponding staples 140 on the shutter blades. The longitudinal edges of the shutter blades overlap each other in the closed position to completely block the light.

The window shutter disclosed herein is preferably made from wood or plastic sheet material. The various components of the window shutter are preferably cut from the sheet material using a CNC router machine 142, such a Camaster Cobra X3, made by Camaster CNC, Inc., Calhoun, Ga. 30701. The process of making the window shutter is similar to that disclosed in copending application Ser. No. 12/752,523, filed Apr. 1, 2010, herein incorporated by reference.

Referring to FIG. 21, the CNC router machine 142 is computer driven and is well know in the art. The machine 142 includes a table surface 144 on which a board 146 to be cut is placed. Alignment or indexing pins 148 hold the board 146 (from which the components of the shutter are cut) in precise location when the board is turned over for cutting on the other side. A router head 150 is movable on the X-Y plane of the table surface 144. The router head 154 is also movable on the Z-axis, which is perpendicular to the X-Y plane.

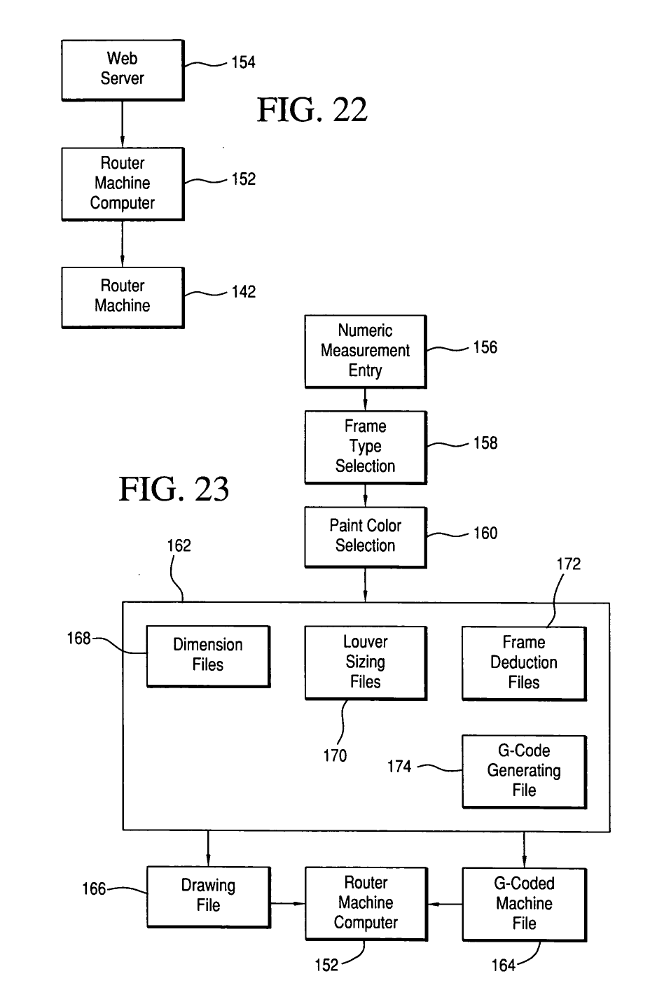

Referring to FIG. 22, the router computer 152 is preferably connected to a web server 154 via the internet or other network connections. The web server 154 includes software that generates the programming steps required to drive the router machine 142 to cut the components of the window shutter from the board 146. Based on the measurements of a window in which the window shutter will be installed, the software in the server 154 will generate the programming steps to drive the router head 150. The server 154 may be connected to a number of other router machines 142 in various locations. An operator for each machine need not know how to program the machine, since the required programming is downloaded to the router machine computer 152 from the server 154 after the operator provides the window measurements.

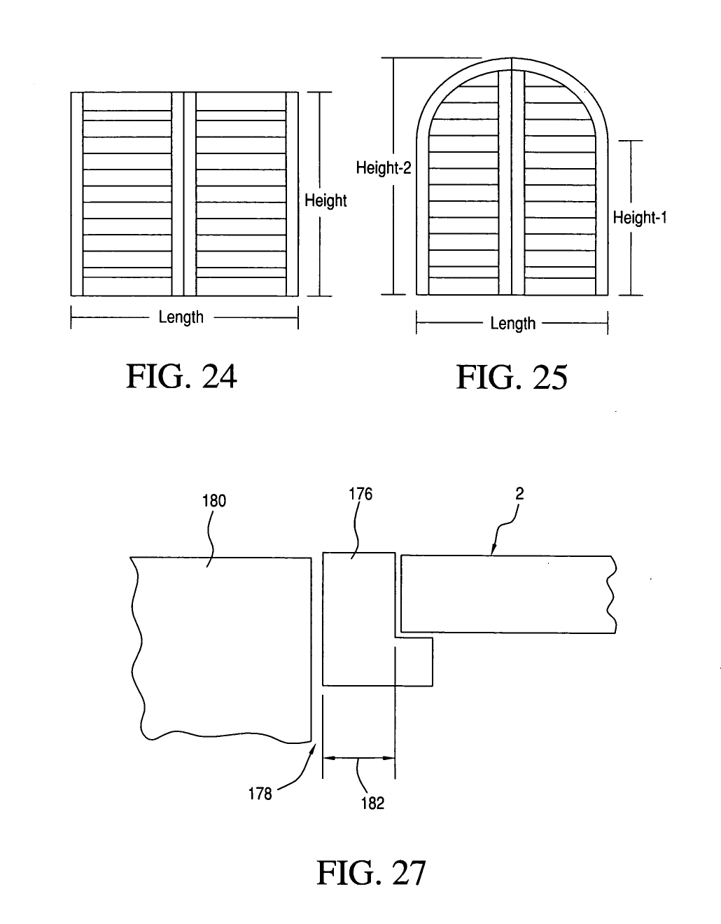

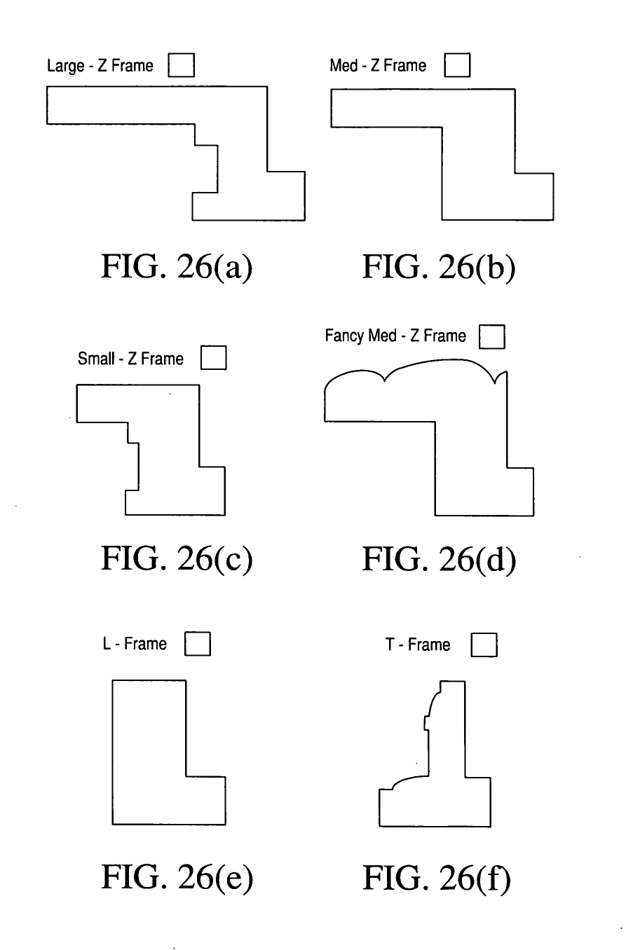

Referring to FIG. 23, an example of the process of making and assembling the various components of the window shutter will now be described. An operator inputs at step 156 the numeric measurements of a window in which the shutter will be installed. In addition to a standard rectangular window opening, as shown in FIG. 24, where the height and width measurements are input into the system, the window opening may also be a half circle with legs, as shown in FIG. 25, where the width, the height-1 at the top center part of the shutters and height-2 of the legs of the shutter are measured. If a frame is added to the shutter 2, a frame type is selected at step 158. Examples of various frame types are shown in FIGS. 26(a)-26(f). Paint color selection may also be made at step 160. These inputs are then sent by the operator to the server 154.

A program 162 resident within the server 154 or in another computer connected to the server 154 converts the operator's input at steps 156 and 158 into a G-code file 164, which is downloaded to the router machine computer 142. In addition, a drawing file 166 is also generated and downloaded to the router machine computer 142. The drawing file 142 generates a drawing of the shutter ordered by the operator as a visual check to the operator on what the shutter looks like before the components are cut by the router machine 76.

The program 162 includes dimension files 168, louver sizing files 170, frame deduction files 172 and G-code generating files 174.

The dimension files 168 are a database developed around the sizes of the shutter, for example as shown in FIGS. 24 and 25. The database consists of measurements of each shutter type, from the smallest to the largest. Since there is rarely two windows of the same size, based on the measurement provided by the operator at step 156, the program searches from the list of dimensions that have been loaded into the database covering, for example, a 18 in.×18 in. window up to a 4 ft. high×8 ft. window. Shutter measurements with width dimensions of 18⅛, 18¼, 18⅜, 18½ and so on up, 95½, 95⅝, 95¾, 95⅞, 96 in; and height measurements of 18⅛, 18¼, 18⅜, 18½ and so on up, 47½, 47⅝, 47¾, 47⅞, 48 in are in the database. The shutter measurements that fit the size of the window in which the shutter will be installed is then selected.

Louver sizing files 170 provide the number of shutter blades appropriate for the size of the window in which the shutter will be installed. As the shutter increases in size, the number of shutter blades also increases. The rectangular shutter has shutter blade width sizes of 2½, 3½ and 4½ in.

The frame deduction files 102 allow for reductions in measurements provided at step 156 to accommodate a frame if ordered by the operator to be included with the shutter. Examples of frame profiles provided in the program are shown in FIGS. 26(a)-26(f). The measurements of these frame profiles have been loaded into the program. Depending on the frame profile chosen, the program calculates the deductions to shrink the shutter size to accommodate the frame. For example, referring to FIG. 27, an L-frame 176 is provided with the shutter 2. The frame 176 will have a clearance 178 of ⅛ in. around the window frame 180. Since the frame face has a dimension 182 of 1 in., the shutter will be 2⅜ in. less in height and 2⅜ in. in width than the measurement provided at step 156.

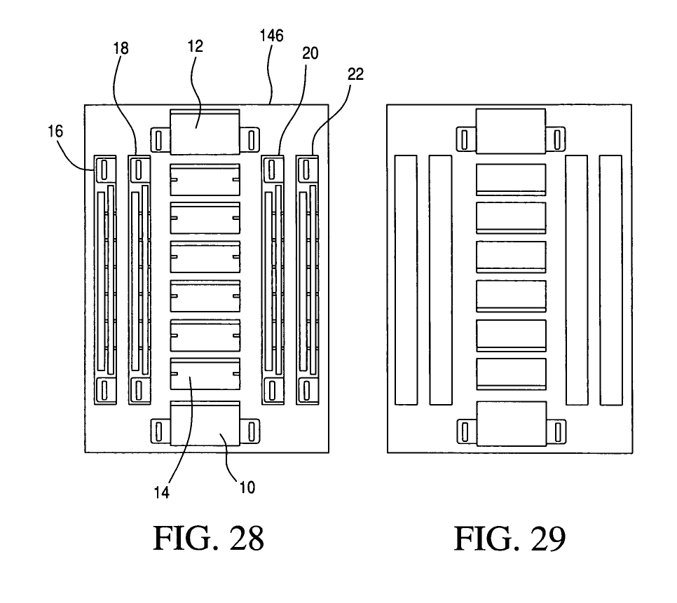

The G-code machine file 164 is standard G-code software used for motion control of the cutting tool of the router machine 142 that does the actual work. The G-code machine file 164 includes router tool selection, machine feed rates, tool speeds, tool paths and cutting depths. The G-codes direct the machine actions, such as rapid move; controlled feed move in a straight line or arc; series of controlled feed moves for boring holes; cutting a work piece to a specific dimension; cutting a decorative profile shape to the edge of a work piece; change tool; etc. The generation of G-codes for driving the router machine 142 are well known in the art. The G-codes may be generated using a standard drawing software package, such as AUTOCAD, available from Autodesk, Inc., 111 McInnis Parkway, San Rafael, Calif. 94903 and a standard G-code generating software package, such as ALPHACAM, available from Planit Solutions, Inc., 3800 Palisades Drive, Tuscaloosa, Ala. 35405. For example, referring to FIGS. 28 and 29, each figure is generated by the drawing software, which is then converted by the G-code generating software into a G-coded machine file that will drive the router machine 142 to cut the various pieces for the shutter. The G-coded machine file is sent to the router machine computer 152 using standard connections, such as the Internet or other network connections.

The generation of the G-coded machine file 164 may also be automated by storing a database of G-code files that would be used in cutting any type and size of shutter for which the system is designed. These G-code files include all the necessary machine operations, such as the tool path, tool selection, depth of cut, tool rpm, feed speed, etc. for cutting the parts for any type and size of shutter stored in the system. Data on the dimensions of the ordered shutter, including the number of shutter blades, and any frame deduction generate a drawing file comprising several layered views. Each view is then associated with the appropriate G-code files already stored in the system. All the selected G-code files for all the views are then sent to the router machine computer 152 via the internet or other network connections.

The cutting process has been described extensively in the copending application Ser. No. 12/752,523. A person of ordinary skill in the art will understand that a similar process is applicable in cutting the various components of the shutter of the present invention. As an example, the various cutting patterns on the board 146, showing the various components, are shown on one side of the board in FIG. 28 and on the other side in FIG. 29. Note that the stile members are identical and symmetrical about a horizontal centerline so that they can be flipped, turned or otherwise rotated during assembly. The shutter blades 14 are identical to each other. The rails 10 and 12 are also identical to each other.

The various components of the window shutter disclosed herein are cut from a sheet strip material, made of synthetic material, such as PVC, or wood. The rails may also be made from pre-cut wood or synthetic strip material using a vacuum jig well known in the art.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

We claim:

1. A plantation window shutter, comprising:
a) a frame and a plurality of shutter blades pivotably supported by said frame;
b) said frame comprising a left stile, a right stile, a bottom rail connected to said left and right stiles and a top rail connected to said left and right stiles;
c) said left stile comprising first and second members joined together, said right stile comprising third and fourth members joined together;
d) said bottom rail including first and second end portions sandwiched between said first and second members, and said third and fourth members, respectively;
e) said top rail including first and second end portions sandwiched between said first and second members, and said third and fourth members, respectively;
f) said left and right stiles including top end portions operably attached to each other;
g) said first and second members having opposing sides including a plurality of mirrored left grooves, said third and fourth members having opposing sides including a plurality of mirrored right grooves, said mirrored left grooves being axially aligned with respective said mirrored right grooves;
and
h) each of said shutter blades having a longitudinal pivotal axis and a left pivot and a right pivot aligned along said axis, said left pivot and said right pivot being received in respective one of said mirrored left grooves and said mirrored right grooves.

2. A plantation window shutter as in claim 1, wherein:
a) said first and second members include first and second bottom end portions, respectively;
b) said third and fourth members include third and fourth bottom end portions, respectively;
c) said first and second bottom portions include first and second projections, respectively;
d) said third and fourth bottom portions include third and fourth projections, respectively;
e) said bottom rail first and second end portions include first and second openings, respectively;
f) said first and second projections are receivable within said first opening; and
g) said third and fourth projections are receivable within said second opening.

3. A plantation window shutter as in claim 1, wherein:
a) said first and second members include first and second top end portions, respectively;
b) said third and fourth members include third and fourth top end portions, respectively;
c) said first and second top portions include first and second projections, respectively;
d) said third and fourth top portions include third and fourth projections, respectively;
e) said top rail first and second end portions include first and second openings, respectively;
f) said first and second projections are receivable within said first opening; and
g) said third and fourth projections are receivable within said second opening.

4. A plantation window shutter as in claim 1, wherein:
a) said first and second members opposing sides include mirrored longitudinal slots disposed transversely to said mirrored left grooves;
b) each of said left pivots include a gear operably associated with a gear rack disposed in said mirrored longitudinal slots; and
c) said gear rack is longitudinally movable within said mirrored longitudinal slots such that rotation of one of said shutter blades causes said gear rack to move, thereby actuating said shutter blades.

5. A plantation window shutter as in claim 1, wherein:
a) said first and second members are identical to each other; and
b) said third and fourth members are identical to each other.

6. A plantation window shutter as in claim 1, wherein said top and bottom rails are identical to each other.

7. A plantation window shutter as in claim 4, wherein said gear rack is slidable within said mirrored longitudinal slots when one of said shutter blades is turned.

8. A plantation window shutter as in claim 1, wherein:
a) each of said pivots includes an attachment portion and a pivot portion; and
b) said attachment portion is received in a correspondingly shaped slot in a respective shutter blade.

9. A plantation window shutter as in claim 8, wherein said attachment portion and said correspondingly shaped slot is T-shaped in cross-section.

10. A plantation window shutter as in claim 8, wherein said attachment portion includes a flange portion disposed over said correspondingly shaped slot when said attachment portion is received within said correspondingly shaped slot.

11. A plantation window shutter as in claim 1, wherein:
a) each of said shutter blades includes upper and lower longitudinal edges, one of said edges includes a rear recess and the other of said edges includes a front recess; and
b) said shutter blades are secured to said frame such that a shutter blade longitudinal top and bottom edges overlap, respectively, an adjacent lower shutter blade top longitudinal edge and an adjacent upper shutter blade lower longitudinal lower edge.

12. A plantation window shutter as in claim 1, wherein:
a) said first and second members include mirrored longitudinal slots;
b) said third and fourth members include another mirrored longitudinal slots; and
c) a stiffener disposed within said mirrored longitudinal slots and said another mirrored longitudinal slots.

13. A plantation window shutter as in claim 12, wherein said stiffener is a square tube.

14. A plantation window shutter as in claim 1, wherein:
a) said bottom rail first and second end portions are reduced in dimensions; and
b) said top rail first and second end portions are reduced in dimensions.

15. A plantation window shutter as in claim 2, wherein:
a) said first, second, third and fourth projections are rectangular in cross-section; and
b) said first and second openings are rectangular.

16. A plantation window shutter as in claim 4, wherein:
a) said gear rack includes a U-shaped housing including a base and a pair of side walls;
b) a linear gear disposed on said base wall;
c) said side walls include respective first and second slots; and
d) said gear is movable along said first and second slots.

17. A plantation window shutter as in claim 1, wherein a number of said pivots include friction washers operably held between said first and second members, and said third and fourth members.

18. A plantation window shutter as in claim 17, and further comprising a control rod hingedly secured to said shutter blades to open and close said shutter blades.

19. A plantation window shutter, comprising:
a) a frame and a plurality of shutter blades pivotably supported by said frame;
b) said frame comprising a left stile, a right stile, a bottom rail connected to said left and right stiles and a top rail connected to said left and right stiles;
c) said left stile comprising first and second members joined together, said right stile comprising third and fourth members joined together;
d) said bottom rail including first and second end portions sandwiched between said first and second members, and said third and fourth members, respectively;
e) said top rail including first and second end portions sandwiched between said first and second members, and said third and fourth members, respectively;
f) said left and right stiles including top end portions operably attached to each other;
g) said first member including a plurality of left grooves, said third member including a plurality of right grooves, said left grooves being axially aligned with respective said right grooves; and
h) each of said shutter blades having a longitudinal pivotal axis and a left pivot and a right pivot aligned along said axis, said left pivot and said right pivot being received in respective one of said left grooves and said right grooves.

20. A method for making a plantation window shutter, comprising the steps of:
a) sending to a remote computer measurements of a window opening in which a window shutter will be installed;
b) providing a sheet material from which components of the window shutter will be cut;
c) providing a CNC router machine for cutting the sheet material;
d) receiving by the CNC router machine from the remote computer a machine file configured for operating the CNC router machine to cut the sheet material to produce the components of the window shutter; and
e) assembling the components.

21. A method as in claim 20, and further comprising:
a) selecting a frame; and
b) said machine file includes a deduction on the measurements of the window opening to accommodate the frame.
